(19) United States
(12) Patent Application Publication
(10) Pub. No.: US 2024/0418599 A1
(43) Pub. Date: Dec. 19, 2024

(54) OPTICAL ELEMENT, OPTICAL UNIT, OPTICAL DEVICE, METHOD FOR ADJUSTING OPTICAL ELEMENT, AND METHOD FOR MANUFACTURING OPTICAL ELEMENT

(71) Applicant: CANON KABUSHIKI KAISHA, Tokyo (JP)

(72) Inventors: MASATSUGU KOYAMA, Kanagawa (JP); TOMONAO NAKAYASU, Kanagawa (JP)

(21) Appl. No.: 18/739,824

(22) Filed: Jun. 11, 2024

(30) Foreign Application Priority Data
Jun. 19, 2023 (JP) 2023-100017

(51) Int. Cl. G01M 11/00; G01M 11/02; G02B 7/182; G02B 27/62

(52) U.S. Cl. CPC G01M 11/005; G01M 11/0214; G01M 11/0264; G02B 7/1822; G02B 27/62

(57) ABSTRACT

An optical element includes a plurality of optical surfaces. At least one of the plurality of optical surfaces includes a main surface extending in a longitudinal direction and a short-side direction, and a mark including a recess portion or a protrusion portion, the mark extending in the longitudinal direction of the main surface.

### BACKGROUND

### Field of the Disclosure

The present disclosure relates to an optical element, an optical unit, an optical device, a method for adjusting an optical element and a method for manufacturing an optical element.

### Description of the Related Art

Japanese Patent Application Laid-Open No. 2013-148437 discloses a detection apparatus that applies a detection mark on an optical element. The detection apparatus is arranged to detect a focusing condition, in which light emitted through an objective lens forms a parallel light beam, based on an image of the detection mark being detected by an image detector.

In recent years, an optical element having a plurality of optical surfaces has been used in various fields such as imaging, observation, measurement, and information technology. In an optical element having a plurality of optical surfaces, the position and posture of the optical element needs to be adjusted with high precision in an attempt to achieve a desired level of optical performance.

### SUMMARY

According to a first aspect of the present disclosure, an optical element includes a plurality of optical surfaces. At least one of the plurality of optical surfaces includes a main surface extending in a longitudinal direction and a short-side direction, and a mark including a recess portion or a protrusion portion, the mark extending in the longitudinal direction of the main surface.

According to a second aspect of the present disclosure, a method for manufacturing an optical element includes a step of preparing a base material, and a step of processing the base material. The step of processing the base material includes forming a main surface extending in a longitudinal direction and a short-side direction, and forming an optical surface including a mark including a recess portion or a protrusion portion extending in the longitudinal direction of the main surface.

Further features of the present disclosure will become apparent from the following description of example embodiments with reference to the attached drawings.

### BRIEF DESCRIPTION OF THE DRAWINGS

FIG. 1A is a perspective view of an optical element according to a first embodiment.

FIG. 1B is a schematic diagram illustrating an example of an optical image of reflection light from a mark of each mirror surface of the optical element according to the first embodiment.

FIG. 2A is an explanatory diagram of the mirror surface according to the first embodiment.

FIG. 2B is a section view of part of the optical element according to the first embodiment.

FIG. 2C is a section view of part of the optical element according to the first embodiment.

FIG. 3A is an explanatory diagram of a method for forming the mirror surface according to the first embodiment.

FIG. 3B is an explanatory diagram of the method for forming the mirror surface according to the first embodiment.

FIG. 4A is an explanatory diagram of a method for forming the mirror surface according to a modification example of the first embodiment.

FIG. 4B is an explanatory diagram of the method for forming the mirror surface according to a modification example of the first embodiment.

FIG. 5A is a diagram for describing positional deviation of the optical element according to the first embodiment in an X-axis direction.

FIG. 5B is a diagram for describing deviation of the optical image projected onto a pixel array derived from the positional deviation of the optical element according to the first embodiment in the X-axis direction.

FIG. 5C is a diagram for describing deviation of the optical image projected onto the pixel array derived from the positional deviation of the optical element according to the first embodiment in the X-axis direction.

FIG. 6A is a diagram for describing positional deviation of the optical element according to the first embodiment in a Y-axis direction.

FIG. 6B is a diagram for describing deviation of the optical image projected onto the pixel array derived from the positional deviation of the optical element according to the first embodiment in the Y-axis direction.

FIG. 6C is a diagram for describing deviation of the optical image projected onto the pixel array derived from the positional deviation of the optical element according to the first embodiment in the Y-axis direction.

FIG. 7A is a diagram for describing positional deviation of the optical element according to the first embodiment in a Z-axis direction.

FIG. 7B is a diagram for describing deviation of the optical image projected onto the pixel array derived from the positional deviation of the optical element according to the first embodiment in the Z-axis direction.

FIG. 7C is a diagram for describing deviation of the optical image projected onto the pixel array derived from the positional deviation of the optical element according to the first embodiment in the Z-axis direction.

FIG. 8A is a diagram for describing posture (e.g., orientation) deviation of the optical element according to the first embodiment about an X axis.

FIG. 8B is a diagram for describing deviation of the optical image projected onto the pixel array derived from the posture deviation of the optical element according to the first embodiment about the X axis.

FIG. 9A is a diagram for describing posture deviation of the optical element according to the first embodiment about the X axis.

FIG. 9B is a diagram for describing deviation of the optical image projected onto the pixel array derived from the posture deviation of the optical element according to the first embodiment about the X axis.

FIG. 10A is a diagram for describing posture deviation of the optical element according to the first embodiment about a Y axis.

FIG. 10B is a diagram for describing deviation of the optical image projected onto the pixel array derived from the posture deviation of the optical element according to the first embodiment about the Y axis.

FIG. 11A is a diagram for describing posture deviation of the optical element according to the first embodiment about the Y axis.

FIG. 11B is a diagram for describing deviation of the optical image projected onto the pixel array derived from the posture deviation of the optical element according to the first embodiment about the Y axis.

FIG. 12A is a diagram for describing posture deviation of the optical element according to the first embodiment about a Z axis.

FIG. 12B is a diagram for describing deviation of the optical image projected onto the pixel array derived from the posture deviation of the optical element according to the first embodiment about the Z axis.

FIG. 13A is a diagram for describing posture deviation of the optical element according to the first embodiment about the Z axis.

FIG. 13B is a diagram for describing deviation of the optical image projected onto the pixel array derived from the posture deviation of the optical element according to the first embodiment about the Z axis.

FIG. 14A is an explanatory diagram of an optical unit according to a second embodiment.

FIG. 14B is an explanatory diagram of an optical unit according to a modification example of the second embodiment.

FIG. 15A is an explanatory diagram of an optical system according to a third embodiment.

FIG. 15B is an explanatory diagram of an optical system according to a fourth embodiment.

FIG. 16 is a diagram illustrating a table of experimental results of examples.

### DESCRIPTION OF THE EMBODIMENTS

The present disclosure provides a technique advantageous for adjusting the position and posture of an optical element with high precision.

Example embodiments of the present disclosure will be described in detail below with reference to drawings. The following embodiments show examples of preferable configurations of the present disclosure, and can be implemented by one skilled in the art with, for example, appropriate modifications of details thereof within the gist of the present disclosure. In addition, in the drawings referred to in the description of the following embodiments, it is assumed that elements denoted by the same reference numerals have substantially the same functions.

### First Embodiment

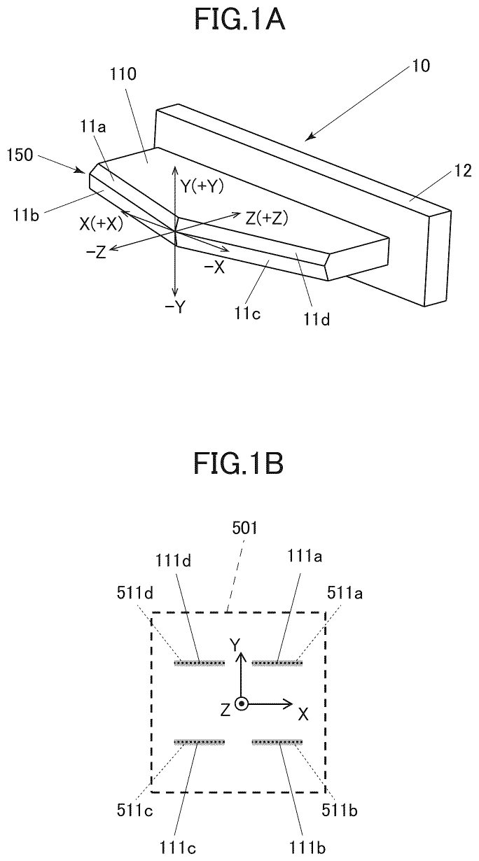

FIG. 1A is a perspective view of an optical element 10 according to the first embodiment. The optical element 10 includes a mirror array 150 having a plurality of mirror surfaces. The mirror surface is an example of an optical surface. Two or more of the plurality of mirror surfaces have a mark (e.g., an optical portion, component or feature) that will be described later. The two or more mirror surfaces each face in a different direction. The two or more mirror surfaces are four mirror surface 11a, 11b, 11c, and 11d in the first embodiment. That is, the optical element 10 includes four mirror surfaces 11a to 11d. The four mirror surfaces 11a to 11d are preferably arranged in an array shape. A case where the optical element 10 includes four mirror surfaces 11a to 11d will be described below, but the configuration is not limited to this, and the optical element 10 may include five or more mirror surfaces.

The optical element 10 is positioned with respect to an unillustrated support member by being supported by the support member such that the position and posture thereof are adjustable with respect to the support member.

The optical element 10 includes a base portion 110 on which the mirror surfaces 11a to 11d are formed, and a supported portion 12 connected to the base portion 110. The supported portion 12 is supported by the unillustrated support member such that the position and posture of each of the mirror surfaces 11a to 11d are adjustable.

An orthogonal coordinate system of an X axis, a Y axis, and a Z axis will be defined with respect to the support member supporting the optical element 10. Since the mirror surfaces 11a to 11d each face in a different direction, light incident on each of the mirror surfaces 11a to 11d from the same direction is reflected in a different direction by the corresponding one of the mirror surfaces 11a to 11d. The light incident direction on the optical element 10 will be referred to as a +Z direction. A direction opposite to the +Z direction will be referred to as a −Z direction. The +Z direction is a positive direction along the Z axis, and the Z-axis direction is a negative direction along the Z axis. Two directions orthogonal to the Z-axis direction will be referred to as an X-axis direction and a Y-axis direction. The X-axis direction and the Y-axis direction are orthogonal to each other. The positive direction along the X axis will be referred to as a +X direction. The negative direction along the X axis will be referred to as a −X direction. The positive direction along the Y axis will be referred to as a +Y direction. The negative direction along the Y axis will be referred to as a-Y direction.

The mirror surfaces 11a to 11d are formed at a distal end of the base portion 110 in the Z-axis direction. The reflection light (e.g., a light beam) from each of the mirror surfaces 11a to 11d (e.g., the light which is reflected therefrom) is projected onto a position different from each other in the X-Y plane. By adjusting the position and posture (e.g., orientation or stance) of the optical element 10, the position of an optical image projected by each of the mirror surfaces 11a to 11d can be adjusted.

The mirror surfaces 11a to 11d each have an optical axis that is individually designed and directed in a direction different from each other. That is, the mirror surfaces 11a to 11d are designed to be at angles different from each other with respect to a reference surface, for example, the X-Y plane. The precision of the position and posture of the optical element 10 affects the precision of the optical performance of an optical device including the optical element 10.

FIG. 1B is a schematic diagram illustrating an example of an optical image of reflection light from a mark 15 (e.g., an optical portion, component, or feature) of each of the mirror surfaces 11a to 11d of the optical element 10 according to the first embodiment that will be described later. To be noted, in FIG. 1B, illustration of an optical image of reflection light from a main surface 13 that will be described later.

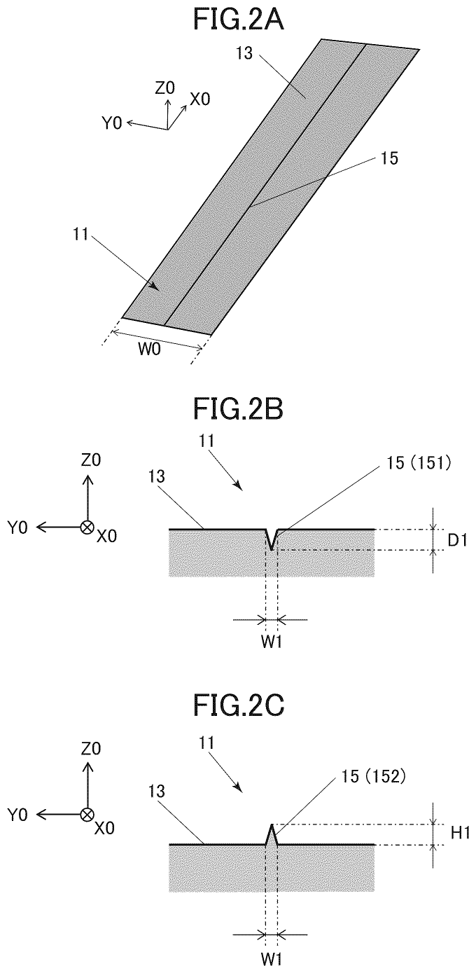

FIG. 2A is an explanatory diagram of a mirror surface 11 according to the first embodiment. Here, the mirror surfaces 11a to 11d each have substantially the same configuration, and each of the mirror surfaces 11a to 11d will be described as the mirror surface 11. Here, an orthogonal coordinate system of an X0 axis, a Y0 axis, and a Z0 axis will be defined with respect to the mirror surface 11. The longitudinal direction of the mirror surface 11 will be referred to as an X0-axis direction, and the short-side direction of the mirror surface 11 will be referred to as a Y0-axis direction. The X0-axis direction and the Y0-axis direction are orthogonal to each other. A direction orthogonal to the X-axis direction and the Y0-axis direction will be referred to as a Z0-axis direction.

The mirror surface 11 includes a main surface 13 and a mark 15. The main surface 13 is a surface extending in the X0-axis direction and the Y0-axis direction, and is a flat surface in the first embodiment. Among surfaces included in the mirror surface 11, the main surface 13 has the largest area. To be noted, the main surface 13 may be a curved surface.

The mark 15 is formed on an effective optical surface. The mark 15 is a mark for adjusting the position and posture of the optical element 10. That is, the mark 15 is a mark that can be used for adjusting the position and posture of the optical element 10. The mark 15 is a mark extending in the X0-axis direction from a first end to a second end among two ends of the main surface 13 in the X0-axis direction. The mark 15 is preferably formed to extend linearly in the X-axis direction. In the first embodiment, the mark 15 extending in the X0-axis direction is formed at the center of the main surface 13 in the Y0-axis direction. The mark 15 is a linear mark formed to be continuous in the X0-axis direction. One mirror surface 11 preferably includes one mark 15. Here, forming the mark 15 at the center of the main surface 13 in the Y0-axis direction includes not only a case where the center of the mark 15 in the X0-axis direction passes through the center of the main surface 13 in the Y0-axis direction but also a case where at least part of the mark 15 passes through the center of the main surface 13 in the Y0-axis direction.

To be noted, although the illustration thereof is omitted, the optical element 10 may further include a mirror surface not including the mark 15 in addition to the mirror surfaces 11a to 11d. In addition, the optical element 10 may further include a mirror surface including the mark 15 in addition to the mirror surfaces 11a to 11d. These mirror surfaces different from the mirror surfaces 11a to 11d may face in the same direction as one of the mirror surfaces 11a to 11d.

FIGS. 2B and 2C are each a section view of part of the optical element 10 according to the first embodiment. The mark 15 may be a recess portion 151 recessed in the Z0-axis direction (negative direction along the Z0 axis) with respect to the main surface 13 as illustrated in FIG. 2B, or may be a protrusion portion 152 protruding in the Z0-axis direction (positive direction along the Z0 axis) with respect to the main surface 13 as illustrated in FIG. 2C. The depth of the recess portion 151 in the Z0-axis direction with respect to the main surface 13 will be denoted by D1. The height of the protrusion portion 152 in the Z0-axis direction with respect to the main surface 13 will be denoted by H1. In addition, the width of the mark 15 in the Y0-axis direction will be denoted by W1, and the width of the mirror surface 11, that is, the width of the main surface 13 in the Y0-axis direction will be denoted by W0. The recess portion 151 has a recess shape in a cross-section along the Y0-Z0 plane. The protrusion portion 152 has a protrusion shape in a cross-section along the Y0-Z0 plane. The recess shape or the protrusion shape is an inspection shape for inspecting the position and posture of the optical element 10. In FIGS. 2B and 2C, the part other than the recess portion 151 and the protrusion portion 152 on the mirror surface 11 is a flat surface, but a recess portion less deep than the recess portion 151 or a protrusion portion less high than the protrusion portion 152 may be formed on the mirror surface 11.

The method for manufacturing the optical element 10 will be described. The method for forming each of the mirror surfaces 11a to 11d of the optical element 10 is the same as each other, and a method for forming one mirror surface 11 of the mirror surfaces 11a to 11d will be described below.

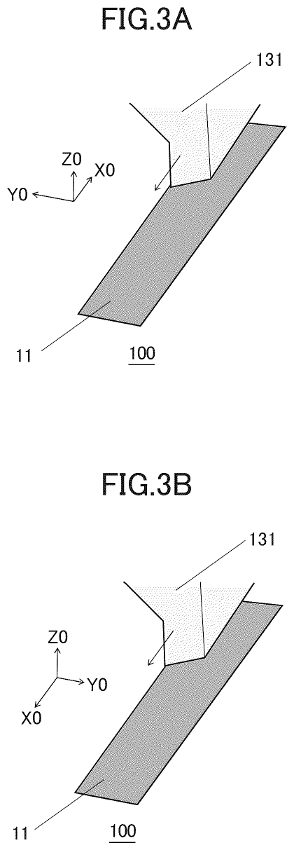

FIGS. 3A and 3B are each an explanatory diagram of a method for forming the mirror surface 11 according to the first embodiment. In the first embodiment, the mirror surface 11 is formed by cutting using one cutting tool 131.

First, a base material 100 is prepared. The base material 100 is, for example, a metal base material. Next, the base material 100 is processed. The mirror surface 11 of the optical element 10 is formed by cutting the base material 100. In the first embodiment, the mirror surface 11 is formed by cutting the base material 100 by the cutting tool 131 having a cutting edge of a width smaller than the width of the mirror surface 11 in the Y0-axis direction.

To be noted, the mirror surface 11 may have a non-optical surface having a sufficiently small width as compared with the width of the effective optical surface in the Y0-axis direction. Alternatively, the mirror surface 11 may have a non-optical surface having a width sufficiently smaller than the width of the cutting edge of the cutting tool 131 in the Y0-axis direction.

In the first embodiment, as illustrated in FIGS. 3A and 3B, the mirror surface 11 is formed by relatively reciprocating the cutting tool 131 in the X0-axis direction with respect to the base material 100. Either of the cutting tool 131 and the base material 100 may be moved in the processing machine. In a forward path in which the cutting tool 131 is relatively moved in the X0-axis direction, a half of the mirror surface 11 in the Y0-axis direction is formed. Then, in the backward path in which the cutting tool 131 is relatively moved in the X0-axis direction, the remaining half of the mirror surface 11 in the Y0-axis direction is formed.

In the backward path in which the cutting tool 131 is relatively moved in the X0-axis direction, the cutting is performed by rotating the cutting tool 131 by 180° about an axis extending in the Z0-axis direction with respect to the mirror surface 11. As a result of this, by performing the cutting by the one cutting tool 131, the mark 15 that is a recess portion 151 or the protrusion portion 152 is formed at the center of the mirror surface 11 in the Y0-axis direction.

In the case where the mark 15 to be formed is the recess portion 151, by overlapping the trajectory of the forward path and the trajectory of the backward path that the cutting tool 131 passes through, the recess portion 151 extending in the X0-axis direction can be formed at the overlapping portion.

In the case where the mark 15 to be formed is the protrusion portion 152, by providing a gap between the trajectory of the forward path and the trajectory of the backward path that the cutting tool 131 passes through, the protrusion portion 152 extending in the X0-axis direction can be formed at the gap portion.

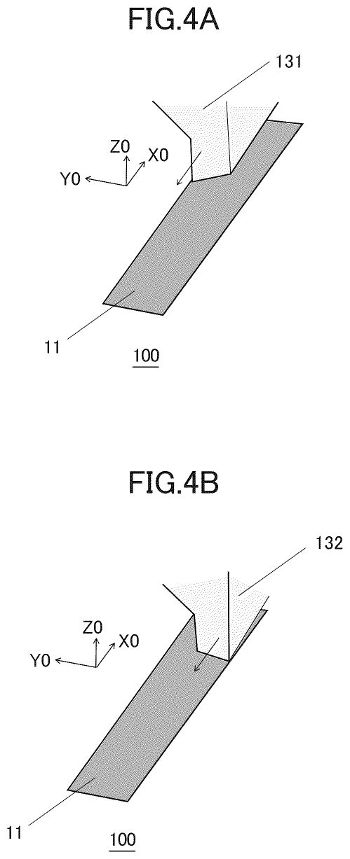

FIGS. 4A and 4B are each an explanatory diagram of a method for forming the mirror surface 11 according to a modification example of the first embodiment. In the modification example of the first embodiment, the mirror surface 11 is formed by cutting using two cutting tools 131 and 132.

In the modification example of the first embodiment, as illustrated in FIGS. 4A and 4B, the mirror surface 11 is formed by moving the cutting tools 131 and 132 each in one direction in the X0-axis direction, for example, in the negative direction along the X0 axis. Any of the cutting tools 131 and 132 and the base material 100 may be moved in the processing machine.

In the cutting using the cutting tool 131, a half of the mirror surface 11 in the Y0-axis direction is formed. Further, in the cutting using the cutting tool 132, the remaining half of the mirror surface 11 in the Y0-axis direction is formed. As a result of this, the mark 15 that is the recess portion 151 or the protrusion portion 152 is formed at the center of the mirror surface 11 in the Y0-axis direction.

In the case where the mark 15 to be formed is the recess portion 151, by overlapping the trajectory of the path that the cutting tool 131 passes through and the trajectory of the path that the cutting tool 132 passes through, the recess portion 151 extending in the X0-axis direction can be formed at the overlapping portion.

In the case where the mark 15 to be formed is the protrusion portion 152, by providing a gap between the trajectory of the path that the cutting tool 131 passes through and the trajectory of the path that the cutting tool 132 passes through without overlap, the protrusion portion 152 extending in the X0-axis direction can be formed at the gap portion.

A method for adjusting the position and posture of the optical element 10 will be described below. The optical element 10 is prepared. In the first embodiment, an unillustrated light source and an unillustrated image sensor are arranged at an interval in the −Z direction from the optical element 10.

The unillustrated light source radiates light onto each of the mirror surfaces 11a to 11d in the +Z direction. As illustrated in FIG. 1B, an optical image of reflection light from the mark 15 of the mirror surface 11a will be denoted by 111a, an optical image of reflection light from the mark 15 of the mirror surface 11b will be denoted by 111b, an optical image of reflection light from the mark 15 of the mirror surface 11c will be denoted by 111c, and an optical image of reflection light from the mark 15 of the mirror surface 11d will be denoted by 111d.

The unillustrated image sensor is a sensor for inspecting the position and posture of the optical element 10, that is, a sensor for detecting the mark 15 of each of the mirror surfaces 11a to 11d. The position and posture of the optical element 10 are adjusted on the basis of an image serving as an inspection result of the image sensor. A region indicated by a broken line is, for example, a pixel array 501 serving as a light receiving surface of the image sensor. The pixel array 501 of the image sensor includes pixel groups 511a, 511b, 511c, and 511d indicated by dotted lines. The pixel group 511a is a pixel group corresponding to a standard position of the optical image 111a, the pixel group 511b is a pixel group corresponding to a standard position of the optical image 111b, the pixel group 511c is a pixel group corresponding to a standard position of the optical image 111c, and the pixel group 511d is a pixel group corresponding to a standard position of the optical image 111d. The lengths of the pixel groups 511a to 511d in the X-axis direction serving as a longitudinal direction are the same predetermined length. That is, the pixel numbers of the pixel groups 511a, 511b, 511c, and 511d in the X-axis direction are the same predetermined pixel number.

In a state in which the optical element 10 is adjusted to standard position and posture, the optical images 111a to 111d respectively overlap with the pixel groups 511a to 511d. In this case, the longitudinal direction of the optical images 111a to 111d is the X-axis direction, and the length of the optical images 111a to 111d in the X-axis direction serving as the longitudinal direction is the predetermined length. That is, in a state in which the optical element 10 is adjusted to the position and posture serving as the standard, the optical images 111a to 111d are respectively projected onto the pixel groups 511a to 511d.

In the first embodiment, light is radiated from the light source onto the optical element 10, and the position and posture of the optical element 10 are adjusted on the basis of the optical images of reflection light reflected from the marks 15 of the mirror surfaces 11a to 11d. At this time, in the first embodiment, an unillustrated image processing apparatus analyzes a captured image captured by the image sensor, and thus the position and posture of the optical element 10 can be detected.

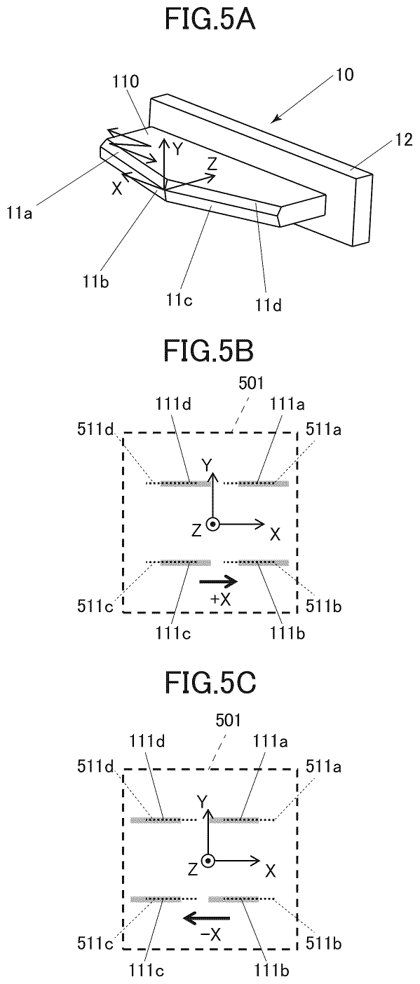

FIG. 5A is a diagram for describing positional deviation of the optical element 10 according to the first embodiment in the X-axis direction, and FIGS. 5B and 5C are each a diagram for describing deviation of the optical image projected onto the pixel array 501 derived from the positional deviation of the optical element 10 according to the first embodiment in the X-axis direction.

FIG. 5B illustrates a case where the optical element 10 is shifted in the +X direction with respect to the standard position. FIG. 5C illustrates a case where the optical element 10 is shifted in the −X direction with respect to the standard position.

In the case where the optical element 10 is shifted in the +X direction with respect to the standard position, the mark 15 of each of the mirror surfaces 11a to 11d is shifted in the +X direction with respect to the standard position corresponding thereto, and therefore the optical images 111a to 111d of reflection light of the marks 15 of the mirror surfaces 11a to 11d are respectively shifted in the +X direction with respect to the pixel groups 511a to 511d. The length of each of the optical images 111a to 111d in the X-axis direction serving as the longitudinal direction is the predetermined length described above.

Similarly, in the case where the optical element 10 is shifted in the −X direction with respect to the standard position, the mark 15 of each of the mirror surfaces 11a to 11d is shifted in the −X direction with respect to the standard position corresponding thereto, and therefore the optical images 111a to 111d of reflection light of the marks 15 of the mirror surfaces 11a to 11d are respectively shifted in the −X direction with respect to the pixel groups 511a to 511d. The length of each of the optical images 111a to 111d in the X-axis direction serving as the longitudinal direction is the predetermined length.

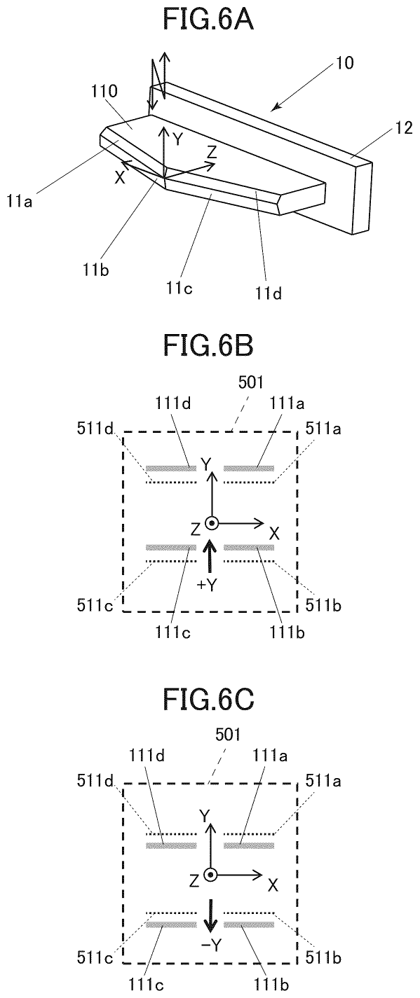

FIG. 6A is a diagram for describing positional deviation of the optical element 10 according to the first embodiment in the Y-axis direction, and FIGS. 6B and 6C are each a diagram for describing deviation of the optical images projected onto the pixel array 501 derived from the positional deviation of the optical element 10 according to the first embodiment in the Y-axis direction.

FIG. 6B illustrates a case where the optical element 10 is shifted in the +Y direction with respect to the standard position. FIG. 6C illustrates a case where the optical element 10 is shifted in the −Y direction with respect to the standard position.

In the case where the optical element 10 is shifted in the +Y direction with respect to the standard position, the mark 15 of each of the mirror surfaces 11a to 11d is shifted in the +Y direction with respect to the standard position corresponding thereto, and therefore the optical images 111a to 111d of reflection light of the marks 15 of the mirror surfaces 11a to 11d are respectively shifted in the +Y direction with respect to the pixel groups 511a to 511d. The length of each of the optical images 111a to 111d in the X-axis direction serving as the longitudinal direction is the predetermined length.

Similarly, in the case where the optical element 10 is shifted in the −Y direction with respect to the standard position, the mark 15 of each of the mirror surfaces 11a to 11d is shifted in the −Y direction with respect to the standard position corresponding thereto, and therefore the optical images 111a to 111d of reflection light of the marks 15 of the mirror surfaces 11a to 11d are respectively shifted in the −Y direction with respect to the pixel groups 511a to 511d. The length of each of the optical images 111a to 111d in the X-axis direction serving as the longitudinal direction is the predetermined length.

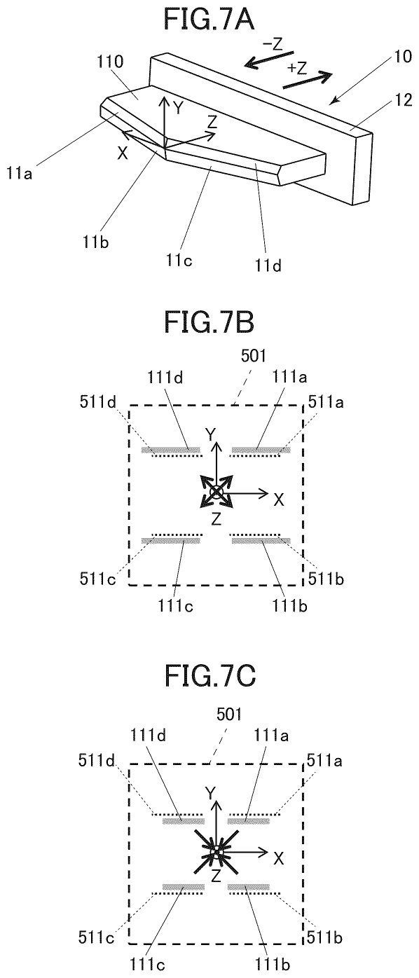

FIG. 7A is a diagram for describing positional deviation of the optical element 10 according to the first embodiment in the Z-axis direction, and FIGS. 7B and 7C are each a diagram for describing deviation of the optical image projected onto the pixel array 501 derived from the positional deviation of the optical element 10 according to the first embodiment in the Z-axis direction.

FIG. 7B illustrates a case where the optical element 10 is shifted in the +Z direction with respect to the standard position. FIG. 7C illustrates a case where the optical element 10 is shifted in the −Z direction with respect to the standard position.

In the case where the optical element 10 is shifted in the +Z direction with respect to the standard position, the mirror surfaces 11a to 11d of the optical element 10 are moved away from the unillustrated light source and the pixel array 501 in the +Z direction. Since the mark 15 of each of the mirror surfaces 11a to 11d is shifted in the +Z direction with respect to the standard position corresponding thereto, the positions of the optical images 111a to 111d of reflection light of the marks 15 of the mirror surfaces 11a to 11d are respectively displaced in a direction away from a predetermined center point in the X-Y plane. In addition, since the optical path becomes longer, the optical images 111a to 111d at positions on the pixel array 501 become larger. That is, the length of each of the optical images 111a to 111d in the X-axis direction serving as the longitudinal direction is larger than the predetermined length.

In the case where the optical element 10 is shifted in the −Z direction with respect to the standard position, the mirror surfaces 11a to 11d of the optical element 10 are moved closer to the unillustrated light source and the pixel array 501 in the −Z direction. Since the mark 15 of each of the mirror surfaces 11a to 11d is shifted in the −Z direction with respect to the standard position corresponding thereto, the positions of the optical images 111a to 111d of reflection light of the marks 15 of the mirror surfaces 11a to 11d are respectively displaced in a direction to move closer to the predetermined center point in the X-Y plane. In addition, since the optical path becomes shorter, the optical images 111a to 111d at positions on the pixel array 501 become smaller. That is, the length of each of the optical images 111a to 111d in the X-axis direction serving as the longitudinal direction is smaller than the predetermined length.

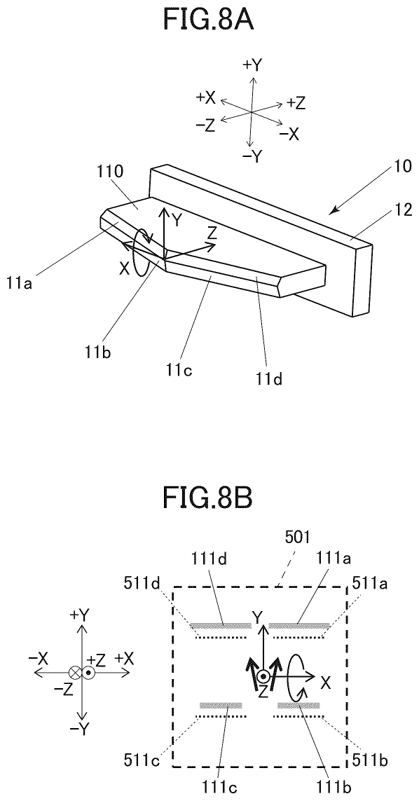

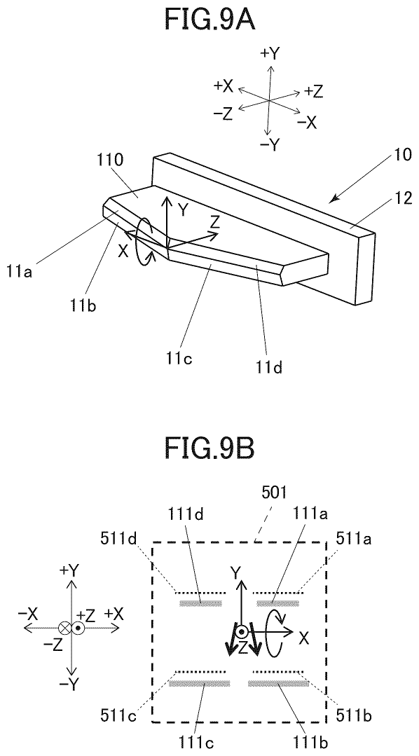

FIGS. 8A and 9A are each a diagram for describing the posture deviation of the optical element 10 according to the first embodiment about the X axis, and FIGS. 8B and 9B are each a diagram for describing deviation of the optical images projected onto the pixel array 501 derived from the posture deviation of the optical element 10 according to the first embodiment about the X axis. FIGS. 8A and 8B illustrate a case where the optical element 10 is tilted rightward about the X axis with respect to the standard posture with the +X direction as the positive direction. FIGS. 9A and 9B illustrate a case where the optical element 10 is tilted leftward about the X axis with respect to the standard posture with the +X direction as the positive direction.

In the case where the optical element 10 is tilted rightward about the X axis with respect to the standard position as viewed in the +X direction as illustrated in FIG. 8A, the mirror surfaces 11a to 11d of the optical element 10 are tilted rightward about the X axis with respect to the unillustrated light source and the pixel array 501 as viewed in the +X direction. Therefore, as illustrated in FIG. 8B, the positions of the optical images 111a to 111d of the reflection light of the marks 15 of the mirror surfaces 11a to 11d are displaced in the +Y direction. In addition, the optical path of the reflection light on the mirror surfaces 11a and 11d side that is the +Y side becomes longer, and the optical path of the reflection light on the mirror surfaces 11b and 11c side that is the −Y side becomes shorter. As a result of this, at positions on the pixel array 501, the optical images 111a and 111d become larger, and the optical images 111b and 111c become smaller. That is, the length of each of the optical images 111a and 111d in the X-axis direction serving as the longitudinal direction becomes larger than the predetermined length, and the length of each of the optical images 111b and 111c in the X-axis direction serving as the longitudinal direction becomes smaller than the predetermined length.

In the case where the optical element 10 is tilted leftward about the X axis with respect to the standard position as viewed in the +X direction as illustrated in FIG. 9A, the mirror surfaces 11a to 11d of the optical element 10 are tilted leftward about the X axis with respect to the unillustrated light source and the pixel array 501 as viewed in the +X direction. Therefore, as illustrated in FIG. 9B, the positions of the optical images 111a to 111d of the reflection light of the marks 15 of the mirror surfaces 11a to 11d are displaced in the −Y direction. In addition, the optical path of the reflection light on the mirror surfaces 11a and 11d side that is the +Y side becomes shorter, and the optical path of the reflection light on the mirror surfaces 11b and 11c side that is the −Y side becomes longer. As a result of this, at positions on the pixel array 501, the optical images 111a and 111d become smaller, and the optical images 111b and 111c become larger. That is, the length of each of the optical images 111a and 111d in the X-axis direction serving as the longitudinal direction becomes smaller than the predetermined length, and the length of each of the optical images 111b and 111c in the X-axis direction serving as the longitudinal direction becomes larger than the predetermined length.

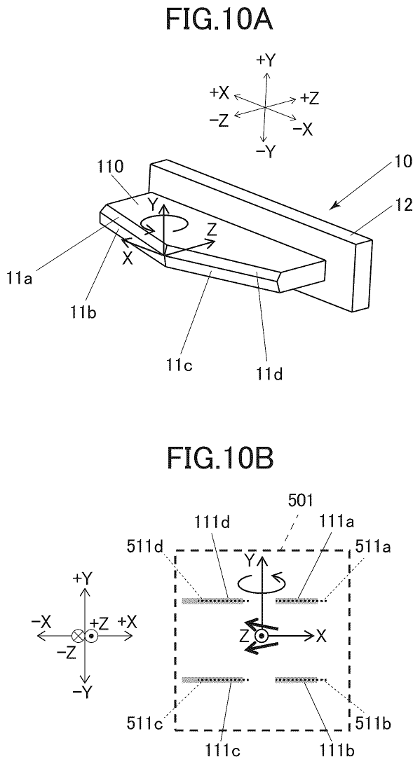

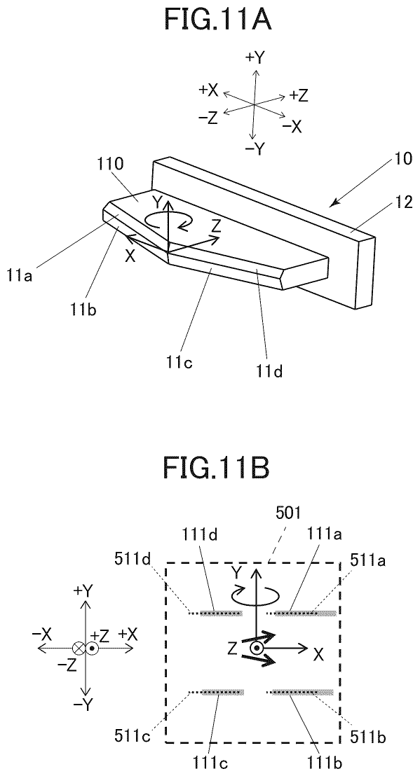

FIGS. 10A and 11A are each a diagram for describing the posture deviation of the optical element 10 according to the first embodiment about the Y axis, and FIGS. 10B and 11B are each a diagram for describing deviation of the optical images projected onto the pixel array 501 derived from the posture deviation of the optical element 10 according to the first embodiment about the Y axis. FIGS. 10A and 10B illustrate a case where the optical element 10 is tilted rightward about the Y axis with respect to the standard posture with the +Y direction as the positive direction. FIGS. 11A and 11B illustrate a case where the optical element 10 is tilted leftward about the Y axis with respect to the standard posture with the +Y direction as the positive direction.

In the case where the optical element 10 is tilted rightward about the Y axis with respect to the standard position as viewed in the +Y direction as illustrated in FIG. 10A, the mirror surfaces 11a to 11d of the optical element 10 are tilted rightward about the Y axis with respect to the unillustrated light source and the pixel array 501 as viewed in the +Y direction. Therefore, as illustrated in FIG. 10B, the positions of the optical images 111a to 111d of the reflection light of the marks 15 of the mirror surfaces 11a to 11d are displaced in the −X direction. In addition, the optical path of the reflection light on the mirror surfaces 11c and 11d side that is the −X side becomes longer, and the optical path of the reflection light on the mirror surfaces 11a and 11b side that is the +X side becomes shorter. As a result of this, at positions on the pixel array 501, the optical images 111c and 111d become larger, and the optical images 111a and 111b become smaller. That is, the length of each of the optical images 111c and 111d in the X-axis direction serving as the longitudinal direction becomes larger than the predetermined length, and the length of each of the optical images 111a and 111b in the X-axis direction serving as the longitudinal direction becomes smaller than the predetermined length.

In the case where the optical element 10 is tilted leftward about the Y axis with respect to the standard position as viewed in the +Y direction as illustrated in FIG. 11A, the mirror surfaces 11a to 11d of the optical element 10 are tilted leftward about the Y axis with respect to the unillustrated light source and the pixel array 501 as viewed in the +Y direction. Therefore, as illustrated in FIG. 11B, the positions of the optical images 111a to 111d of the reflection light of the marks 15 of the mirror surfaces 11a to 11d are displaced in the +X direction. In addition, the optical path of the reflection light on the mirror surfaces 11c and 11d side that is the −X side becomes shorter, and the optical path of the reflection light on the mirror surfaces 11a and 11b side that is the +X side becomes longer. As a result of this, at positions on the pixel array 501, the optical images 111c and 111d become smaller, and the optical images 111a and 111b become larger. That is, the length of each of the optical images 111c and 111d in the X-axis direction serving as the longitudinal direction becomes smaller than the predetermined length, and the length of each of the optical images 111a and 111b in the X-axis direction serving as the longitudinal direction becomes larger than the predetermined length.

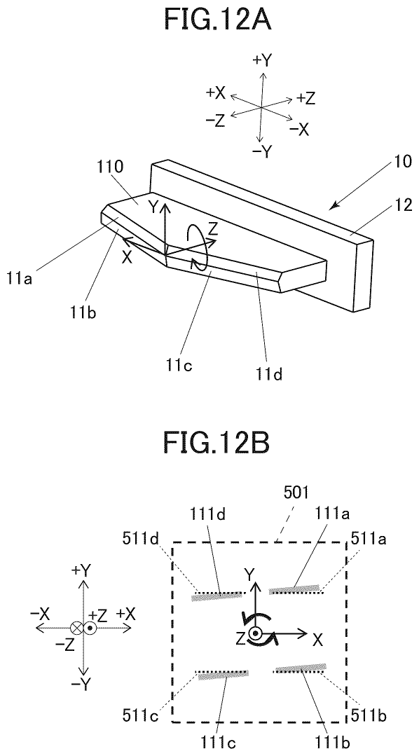

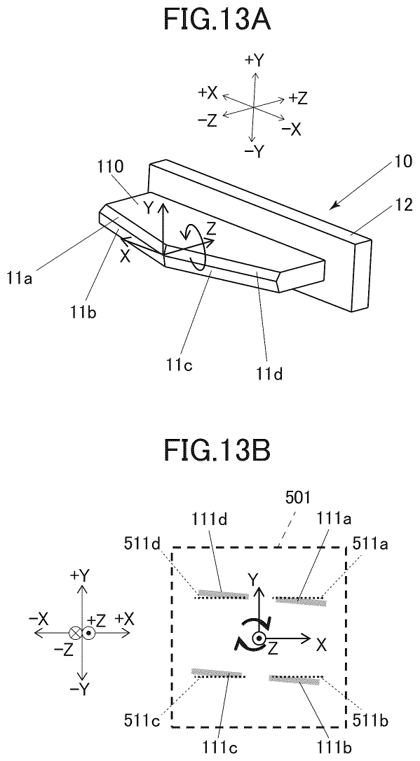

FIGS. 12A and 13A are each a diagram for describing the posture deviation of the optical element 10 according to the first embodiment about the Z axis, and FIGS. 12B and 13B are each a diagram for describing deviation of the optical images projected onto the pixel array 501 derived from the posture deviation of the optical element 10 according to the first embodiment about the Z axis. FIGS. 12A and 12B illustrate a case where the optical element 10 is tilted rightward about the Z axis with respect to the standard posture with the +Z direction as the positive direction. FIGS. 13A and 13B illustrate a case where the optical element 10 is tilted leftward about the Z axis with respect to the standard posture with the +Z direction as the positive direction.

In the case where the optical element 10 is rotated rightward about the Z axis with respect to the standard posture as viewed in the +Z direction as illustrated in FIG. 12A, the mirror surfaces 11a to 11d of the optical element 10 are rotated rightward about the Z axis with respect to the unillustrated light source and the pixel array 501 as viewed in the +Z direction. Therefore, as illustrated in FIG. 12B, the positions of the optical images 111a to 111d of the reflection light of the marks 15 of the mirror surfaces 11a to 11d are rotated rightward about the Z axis as viewed in the +Z direction. The longitudinal direction of each of the optical images 111a to 111d is tilted with respect to the X-axis direction, and the length of each of the optical images 111a to 111d in the longitudinal direction is the predetermined length.

In the case where the optical element 10 is rotated leftward about the Z axis with respect to the standard posture as viewed in the +Z direction as illustrated in FIG. 13A, the mirror surfaces 11a to 11d of the optical element 10 are rotated leftward about the Z axis with respect to the unillustrated light source and the pixel array 501 as viewed in the +Z direction. Therefore, as illustrated in FIG. 13B, the positions of the optical images 111a to 111d of the reflection light of the marks 15 of the mirror surfaces 11a to 11d are rotated leftward about the Z axis as viewed in the +Z direction. The longitudinal direction of each of the optical images 111a to 111d is tilted with respect to the X-axis direction, and the length of each of the optical images 111a to 111d in the longitudinal direction is the predetermined length.

As described above, according to the first embodiment, by observing the optical images 111a to 111d projected by the marks 15 included in the mirror surfaces 11a to 11d when the optical element 10 is placed on the unillustrated support member, the deviation of the position and posture of the optical element 10 with respect to the position and posture serving as the standard can be obtained, and thus the position and posture of the optical element 10 can be easily adjusted to the position and posture serving as the standard. Specifically, by observing the position, size, and inclination of the optical images 111a to 111d, the shift of the optical element 10 in the X-axis, Y-axis, and Z-axis directions, the tilt of the optical element 10 about the X and Y axes, and the rotation of the optical element 10 about the Z axis can be obtained, and therefore, the position and posture of the optical element 10 can be easily adjusted to the position and posture serving as the standard.

To be noted, although a case where the position and posture of the optical element 10 are inspected by irradiating the optical element 10 with light and projecting the reflection light thereof onto the image sensor has been described, the configuration is not limited to this. For example, the position and posture of the optical element 10 may be inspected by directly observing the mark 15 included in the mirror surface 11 by using a differential interference contrast microscope. In this case, it suffices if the mark 15 is included in at least one of the plurality of mirror surfaces 11 of the optical element 10. By using a differential interference contrast microscope, the position and posture of the optical element 10 with respect to the standard surface can be easily inspected in a state in which the optical element 10 is installed.

### Second Embodiment

A second embodiment of the present disclosure will be described. In the description below, it is assumed that elements denoted by the same reference signs as in the first embodiment have substantially the same configurations and functions as those described in the first embodiment unless otherwise described, and parts different from the first embodiment will be mainly described.

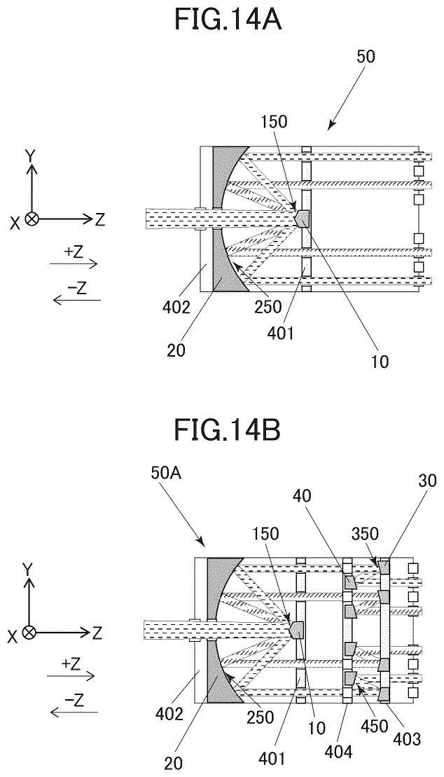

FIG. 14A is an explanatory diagram of an optical unit 50 according to the second embodiment. The optical unit 50 includes the optical element 10 described in the first embodiment, an optical element 20 different from the optical element 10, a support member 401 supporting the optical element 10, and a support member 402 supporting the optical element 20. The optical element 10 is an example of a first optical element, and the optical element 20 is an example of a second optical element. The supported portion 12 of the optical element 10 illustrated in FIG. 1 is supported by the support member 401 such that the position and posture of the optical element 10 are adjustable. The support members 401 and 402 are positioned with respect to each other.

The optical element 20 includes a mirror array 250 including the same number of mirror surfaces as the mirror array 150 of the optical element 10. Since the mirror array 150 includes four mirror surfaces, the mirror array 250 includes four mirror surfaces.

The optical element 20 is disposed at a position away from the optical element 10 in the −Z direction opposite to the +Z direction in which the light is incident on the optical element 10. Further, the plurality of mirror surfaces of the mirror array 250 of the optical element 20 reflect reflection light (light beams) from the plurality of mirror surfaces of the mirror array 150 of the optical element 10 respectively in the +Z direction. The +Z direction is an example of a first direction, and the −Z direction is an example of a second direction. The position and posture of the optical element 10 are adjusted with respect to the support member 401 such that the plurality of reflection light beams reflected by the mirror array 250 are emitted in the +Z direction to be parallel with each other.

Also in the optical element 10 of the optical unit 50 configured in this manner, similarly to the first embodiment, by observing the position, size, and inclination of the optical image corresponding to the mark 15 included in the reflection light of the optical element 10, the shift of the optical element 10 in the X-axis, Y-axis, and Z-axis directions, the tilt of the optical element 10 about the X and Y axes, and the rotation of the optical element 10 about the Z axis can be obtained, and thus the position and posture of the optical element 10 can be easily adjusted to the position and posture serving as the standard.

In addition, the optical element 20 is disposed on the support member 402 so as to oppose the optical element 10. The behavior of the plurality of light beams emitted from the optical element 20 by the shift in the X-axis, Y-axis, and Z-axis directions is the same as the behavior of the plurality of light beams emitted from the optical element 10, and the shift in the X-axis, Y-axis, and Z-axis directions of the optical element 20 can be inspected by a method similar to the first embodiment. The behavior of the plurality of light beams emitted from the optical element 20 by the rotation about the Z axis is the same as the behavior of the plurality of light beams emitted from the optical element 10, and the rotation about the Z axis of the optical element 20 can be inspected by a method similar to the first embodiment. Meanwhile, the tilt of the optical element 20 about the X and Y axes can be inspected by using a differential interference contrast microscope.

### Modification Example of Second Embodiment

The number of optical elements included in the optical unit is not limited to two, and may be three or more. FIG. 14B is an explanatory diagram of an optical unit 50A according to a modification example of the second embodiment. The optical unit 50A includes the optical element 10, the support member 401 supporting the optical element 10, the optical element 20, the support member 402 supporting the optical element 20, an optical element 30, a support member 403 supporting the optical element 30, an optical element 40, and a support member 404 supporting the optical element 40. The optical element 10 is an example of a first optical element, the optical element 20 is an example of a second optical element, the optical element 30 is an example of a third optical element, and the optical element 40 is an example of a fourth optical element.

The optical element 30 includes a mirror array 350 including the same number of mirror surfaces as the mirror array 150 of the optical element 10. Since the mirror array 150 includes four mirror surfaces, the mirror array 350 includes four mirror surfaces. The optical element 40 includes a mirror array 450 including the same number of mirror surfaces as the mirror array 150 of the optical element 10. Since the mirror array 150 includes four mirror surfaces, the mirror array 450 includes four mirror surfaces.

The optical element 30 is disposed at a position away from the optical element 10 in the +Z direction. The optical element 40 is disposed between the optical elements 10 and 30 in the Z-axis direction. The mirror array 450 of the optical element 40 reflects reflection light from the mirror array 350 of the optical element 30 in the +Z direction.

That is, a plurality of light beams reflected by the mirror array 150 of the optical element 10 are incident on the mirror array 250 of the optical element 20 and reflected by the mirror array 250. The plurality of light beams reflected by the mirror array 250 of the optical element 20 are incident on the mirror array 350 of the optical element 30 and reflected by the mirror array 350. The plurality of light beams reflected by the mirror array 350 of the optical element 30 are incident on the mirror array 450 of the optical element 40 and reflected by the mirror array 450. The plurality of light beams reflected by the mirror array 450 of the optical element 40 are output from an emitting surface of the optical unit 50A.

In the modification example of the second embodiment, the position and posture of the optical elements 10 to 40 can be inspected by using the position of the reflection light emitted from the emitting surface of the optical unit 50A. Although the position and posture of each of the optical elements 10 to 40 can be inspected individually by using the position of the optical image corresponding to the mark 15 of the mirror surface of the optical element 10, the position and posture of the optical elements 10 to 40 can be also inspected by reflecting light by the mirror surface of the plurality of optical elements 10 to 40 and using the position of optical images formed at the focus position of the reflection light.

The optical element 10 and the optical element 30 reflect light in the −Z direction, and are the same in the behavior of the positional change of the optical image corresponding to the mark 15. The optical element 20 and the optical element 40 reflect light in the −Z direction, and are the same in the behavior of the positional change of the optical image corresponding to the mark 15. Therefore, similarly to the second embodiment, the position and posture of the optical elements 10 to 40 can be inspected.

### Third Embodiment

A third embodiment of the present disclosure will be described. In the description below, it is assumed that elements denoted by the same reference signs as in the first embodiment or the second embodiment have substantially the same configurations and functions as those described in the first embodiment or the second embodiment unless otherwise described, and parts different from the first embodiment or the second embodiment will be mainly described.

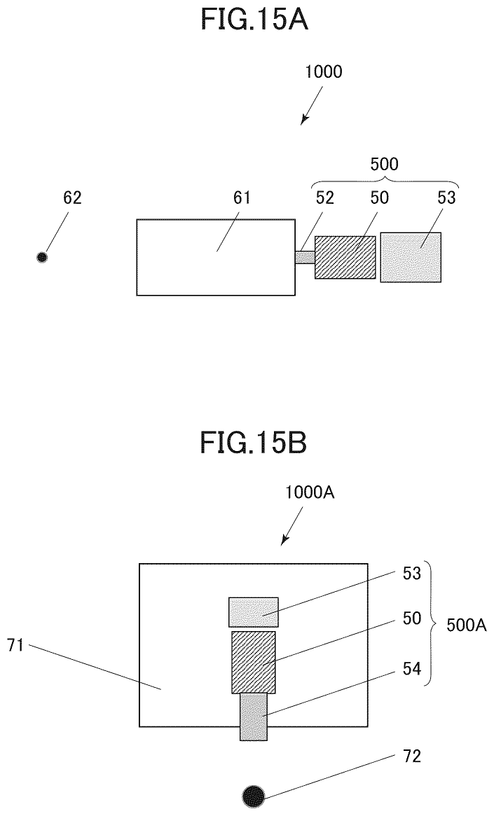

FIG. 15A is an explanatory diagram of an optical system 1000 according to the third embodiment. The optical system 1000 includes an observing apparatus 61 and an optical device 500. The optical device 500 includes the optical unit 50, a connecting portion 52, and an image pickup apparatus 53.

The observing apparatus 61 is a light collecting apparatus for performing spectral analysis on light received from an observation target 62, and is an astronomical telescope in the case where the observation target 62 is an astronomical body. The light collecting method of the observing apparatus 61 may be either a refraction type or a reflection type, but it is preferable that attenuation of light in the wavelength range to be observed through transmission and reflection is within a range that does not hinder the spectral analysis.

The image pickup apparatus 53 is a digital camera including an image sensor. The image pickup apparatus 53 captures an optical image formed by light collected by the observing apparatus 61, and outputs an observation image. In the third embodiment in which spectral analysis is performed, the optical unit 50 is disposed in front of the image pickup apparatus 53, that is, between the observing apparatus 61 and the image pickup apparatus 53.

In the case where the focus position on the image pickup apparatus 53 and the focus position on the optical unit 50 when the observing apparatus 61 performs only normal observation are different, it is preferable that the connecting portion 52 is disposed between the observing apparatus 61 and the optical unit 50. In addition, depending on the wavelength to be subjected to spectral analysis, a filter that passes light of a predetermined wavelength range may be disposed in front of the optical unit 50 or in front of the observing apparatus 61. The spectral analysis is analysis of performing wavelength analysis by using the light diffraction phenomenon. Depending on the diffraction angle of the diffraction grating, light of different wavelengths can overlap on the light receiving portion of the image pickup apparatus 53. Therefore, the filter is used for limiting the wavelength range. The diffraction grating may be provided as a diffraction function of one of the optical elements constituting the optical unit 50, or may be disposed between the optical unit 50 and the image pickup apparatus 53.

In the spectral analysis, the observing apparatus 61 collects the light emitted from the observation target 62 to the eyepiece side from an opening portion. The opening portion corresponds to the object side, that is, the objective lens side.

The collected light is introduced into the optical unit 50 through the connecting portion 52. The light introduced into the optical unit 50 is divided by the mirror array 150 of the optical element 10, and is emitted from the emitting surface via the optical element 20. The light emitted from the emitting surface of the optical unit 50 is broken down in accordance with the wavelength by using a diffraction grating that diffracts light of a predetermined wavelength range, and is captured by the image pickup apparatus 53. As a result of this, an observation image emitted from the observation target 62 is directly subjected to spectral analysis by the observing apparatus 61.

To be noted, in the optical device 500, the optical unit 50A may be used instead of the optical unit 50.

### Fourth Embodiment

A fourth embodiment of the present disclosure will be described. In the description below, it is assumed that elements denoted by the same reference signs as in the first to third embodiments have substantially the same configurations and functions as those described in the first to third embodiments unless otherwise described, and parts different from the first to third embodiments will be mainly described.

FIG. 15B is an explanatory diagram of an optical system 1000A according to the fourth embodiment. The optical system 1000A includes an optical device 500A. The optical device 500A is an analysis apparatus 71, and includes the optical unit 50, a lens 54, and the image pickup apparatus 53.

The analysis apparatus 71 is an apparatus that divides the light received from an analysis target 72 into spectra in accordance with the wavelength and analyzes the spectra, and a representative example thereof is a spectral camera. In the case of observing a visible light image of the analysis target 72 together with the analysis result of the analysis apparatus 71, an unillustrated image pickup apparatus that images the analysis target 72 may be provided together with the analysis apparatus 71.

The light emitted from the analysis target 72 is introduced into the optical unit 50, and a lens 54 such as a camera lens is provided in the case where the light needs to be focused. The lens 54 disposed on the object side of the analysis apparatus 71 collects the light of the analysis target 72 to the optical unit 50 side, and introduces the light into the optical unit 50.

The light introduced into the optical unit 50 is divided by the mirror array 150 of the optical element 10 of the optical unit 50, and is emitted from the emitting surface via the optical element 20. The light emitted from the emitting surface of the optical unit 50 is broken down in accordance with the wavelength by using a diffraction grating that diffracts light of a predetermined wavelength range, and is captured by the image pickup apparatus 53. As a result of this, an observation image emitted from the analysis target 72 is directly subjected to spectral analysis by the analysis apparatus 71.

To be noted, miniaturization can be realized by providing one of the optical elements 10 and 20 constituting the optical unit 50 with a diffraction function. In addition, in the analysis apparatus 71 that is the optical device 500A, the optical unit 50A may be used instead of the optical unit 50.

In the case where the analysis target 72 is a product moving in a transport line, the analysis apparatus 71 that is the optical device 500A can be used when simultaneously analyzing a visible light image and a spectral analysis image. By forming the analysis apparatus 71 as a unit, the analysis apparatus 71 can be moved in a factory or an apparatus, and for example, by moving the analysis apparatus 71 by a moving apparatus such as an unmanned aerial vehicle, spectral analysis can be performed in various spaces such as an outdoor space.

### EXAMPLES

Examples corresponding to the first embodiment will be described. In the examples, the optical element 10 illustrated in FIG. 1 was manufactured. The width of the mirror surface 11 in the short-side direction was set to 1.0 mm, and the length of the mirror surface 11 in the longitudinal direction was set to 50 mm.

The mirror surface 11 was formed by cutting. The cutting tool used for the cutting was a horizontally symmetrical tool that is a diamond tool having a width of 0.1 mm. The base material was cut by moving the cutting tool in the longitudinal direction, and thus the mirror surface 11 was formed. The mark 15 of a predetermined width was formed at the center of the mirror surface 11 in the short-side direction.

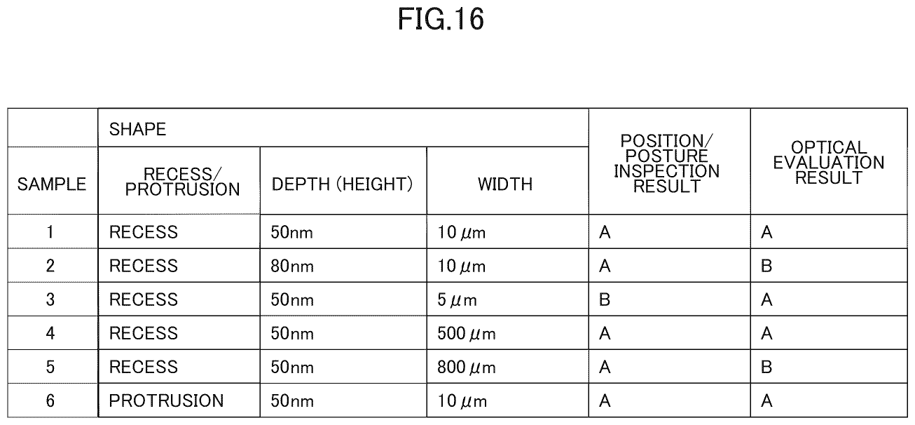

FIG. 16 is a diagram illustrating a table of experimental results of the examples. In the examples, six samples 1 to 6 were formed. FIG. 16 describes the shape of the mark 15 of each of the samples 1 to 6. To be noted, in FIG. 16, the value indicates the depth in the case of a recess portion, and indicates the height in the case of a protrusion portion.

The deviation of the position and posture of the optical element 10 from the standard position and posture was inspected by using the mark 15. In addition, the optical performance of the mirror surface 11 on which the mark 15 was provided was evaluated. The inspection results of the position and posture and the evaluation results of the optical performance are indicated by “A” and “B”. “A” and “B” are each in a range acceptable for the use as the optical element 10 in the optical unit or the like. “A” indicates a better result than “B”.

The mark 15 in the samples 1 to 5 is the recess portion 151, and the mark 15 in the sample 6 is the protrusion portion 152.

In the samples 1 to 6, the optical element 10 was shifted by 0.005 mm in the Y-axis direction from the standard position, and was rotated by 0.0023° rightward from the standard posture as viewed in the +Z direction.

In the samples 1, 2, 4, 5, and 6, the fact that the optical element 10 was rotated by about 0.0023° in terms of the rotational angle was easily inspected. By using the mark 15 provided at the center of the mirror surface 11 as a reference, the position and posture of the optical element 10 could be stably inspected even by using the mirror array 150 whose mirror surface 11 serving as an effective optical surface was inclined. In addition, although parallax occurred at the ridgeline of the mirror array 150 and in the width direction of the mirror surface 11 serving as an effective optical surface due to the inclination of the mirror array 150, the position and posture could be easily inspected. Therefore, in the samples 1, 2, 4, 5, and 6, the inspection result of the position and posture was “A”.

In contrast, in the sample 3, the width of the mark 15 was 5 μm, which was smaller than the width of 10 μm to 800 μm of the marks 15 of the other samples 1, 2, 4, 5, and 6, and therefore the optical image corresponding to the mark 15 was small, and the inspection result of the position and posture was “B”.

In addition, in the samples 1, 3, 4, and 6, the optical image obtained from the mirror surface 11 was good and was not distorted, and therefore the evaluation result of the optical performance was “A”.

In contrast, in the sample 2, the depth of the recess portion 151 was 80 nm, which was larger than the depth of 50 nm of the recess portion 151 or the height of 50 nm of the protrusion portion 152 of the other samples 1, 3, 4, and 6, the optical image was more distorted than in the other samples 1, 3, 4, and 6, and therefore the evaluation result of the optical performance was “B”.

In addition, in the sample 5, the width of the mark 15 was 800 μm, which was larger than the width of 10 μm to 500 μm of the mark 15 of the other samples 1, 3, 4, and 6, the optical image was more distorted than in the other samples 1, 3, 4, and 6, and therefore the evaluation result of the optical performance was “B”.

From the results described above and with reference to FIGS. 2A to 2C, in the case where the mark 15 is the recess portion 151, the depth D1 of the recess portion 151 with respect to the main surface 13 is preferably 50 nm or less. In addition, in the case where the mark 15 is the protrusion portion 152, the height H1 of the protrusion portion 152 with respect to the main surface 13 is preferably 50 nm or less. The width W1 of the mark 15 in the Y0-axis direction is preferably 10 μm or more and 500 μm or less. In other words, the width W1 of the mark 15 in the Y0-axis direction is preferably ½ or less of the width W0 of the main surface 13 in the Y0-axis direction. In addition, the width W1 of the mark 15 in the Y0-axis direction is preferably 1/100 or more of the width W0 of the main surface 13 in the Y0-axis direction.

According to the present disclosure, a technique advantageous for adjusting the position and posture of an optical element with high precision is provided.

The present disclosure is not limited to the embodiments described above, and the embodiments can be modified in many ways within the technical concept of the present disclosure. In addition, the effects described in the embodiments are merely enumeration of the most preferable effects that can be obtained from the embodiments of the present disclosure, and the effects of the embodiments of the present disclosure are not limited to those described in the embodiments.

The disclosure of the present specification is not limited to what is explicitly described in the present specification, and includes all the matter that can be grasped from the present specification and drawings attached to the present specification. In addition, the disclosure of the present specification includes a complementary set of individual concepts described in the present specification. That is, for example, if the present specification includes a description of “A is B”, it can be said that the present specification discloses “A is not B” even if description of “A is not B” is omitted. This is because “A is B” is described on the premise that a case of “A is not B” has been considered.

While the present disclosure has been described with reference to example embodiments, it is to be understood that the disclosure is not limited to the disclosed example embodiments. The scope of the following claims encompasses all such modifications and equivalent structures and functions.

This application claims the benefit of Japanese Patent Application No. 2023-100017, filed Jun. 19, 2023, which is hereby incorporated by reference herein in its entirety.

What is claimed is:

1. An optical element comprising:
a plurality of optical surfaces,
wherein at least one of the plurality of optical surfaces comprises:
a main surface extending in a longitudinal direction and a short-side direction, and
a mark including a recess portion or a protrusion portion, the mark extending in the longitudinal direction of the main surface.

2. The optical element according to claim 1, wherein the at least one of the plurality of optical surfaces is two or more optical surfaces facing in different directions from each other.

3. The optical element according to claim 2, wherein the two or more optical surfaces are four or more optical surfaces.

4. The optical element according to claim 3, wherein the four or more optical surfaces are arranged in an array shape.

5. The optical element according to claim 1, wherein the mark is provided at a center of the main surface in the short-side direction.

6. The optical element according to claim 1,
wherein the mark is the recess portion, and
wherein a depth of the recess portion with respect to the main surface is 50 nm or less.

7. The optical element according to claim 1,
wherein the mark is the protrusion portion, and
wherein a height of the protrusion portion with respect to the main surface is 50 nm or less.

8. The optical element according to claim 1, wherein a width of the mark in the short-side direction is 10 μm or more and 500 μm or less.

9. The optical element according to claim 1, wherein a width of the mark in the short-side direction is ½ or less of a width of the main surface in the short-side direction.

10. The optical element according to claim 1, wherein the at least one of the plurality of optical surfaces is at least one mirror surface.

11. The optical element according to claim 1, wherein the main surface is a flat surface.

12. The optical element according to claim 1, further comprising a supported portion supported by a support member.

13. The optical element according to claim 1, wherein the mark is a mark for adjusting position and posture of the optical element.

14. An optical unit comprising:
the optical element according to claim 1; and
a support member configured to support the optical element.

15. The optical unit according to claim 14, wherein the support member is configured to support the optical element such that position and posture of the optical element are adjustable.

16. The optical unit according to claim 14,
wherein the optical element is a first optical element, and
wherein the optical unit further comprises a second optical element disposed at a position away from the first optical element in a second direction opposite to a first direction in which light is incident on the first optical element and configured to reflect reflection light from the first optical element in the first direction.

17. The optical unit according to claim 16, further comprising:
a third optical element configured to reflect light that is reflected from the second optical element; and
a fourth optical element configured to reflect light that is reflected from the third optical element in the first direction.

18. An optical device comprising:
the optical unit according to claim 14; and
an image pickup apparatus configured to image light from the optical unit.

19. A method for adjusting an optical element, the method comprising:
preparing the optical element according to claim 1;
irradiating the optical element with light; and
adjusting position and posture of the optical element based on an optical image of light that is reflected by the mark.

20. A method for manufacturing an optical element, the method comprising:
a step of preparing a base material; and
a step of processing the base material,
wherein the step of processing the base material comprises:
forming a main surface extending in a longitudinal direction and a short-side direction; and
forming an optical surface including a mark including a recess portion or a protrusion portion extending in the longitudinal direction of the main surface.

21. The method according to claim 20, wherein the main surface and/or the optical surface are formed by cutting.
